(19) United States
(12) Patent Application Publication
(10) Pub. No.: US 2014/0118728 A1
(43) Pub. Date: May 1, 2014

(54) DETECTION APPARATUS, LITHOGRAPHY APPARATUS, METHOD OF MANUFACTURING ARTICLE, AND DETECTION METHOD

(71) Applicant: CANON KABUSHIKI KAISHA, Tokyo (JP)

(72) Inventors: Yoshihiro SHIODE, Utsunomiya-shi (JP); Izumi KAWAHARA, Utsunomiya-shi (JP)

(73) Assignee: CANON KABUSHIKI KAISHA, Tokyo (JP)

(21) Appl. No.: 14/059,690

(22) Filed: Oct. 22, 2013

(30) Foreign Application Priority Data
Oct. 26, 2012 (JP) 2012-237266
Sep. 24, 2013 (JP) 2013-197509

(51) Int. Cl. G01N 21/94

(52) U.S. Cl. CPC G01N 21/94
USPC 356/237.4; 355/30

(57) ABSTRACT

The present invention provides a detection apparatus for detecting a foreign particle on a substrate, including a plate having a first pattern on a first face, a second pattern laid out on a second face different from the first face, a driving mechanism configured to bring the substrate and the plate into contact with each other, a measurement unit configured to measure a relative position deviation between the first pattern and the second pattern in a state in which the substrate and the plate are in contact with each other, and a processing unit configured to execute processing for detecting a foreign particle on the substrate based on the position deviation measured by the measurement unit.

### BACKGROUND OF THE INVENTION

1. Field of the Invention

The present invention relates to a detection apparatus which detects foreign particles on a substrate, a lithography apparatus, a method of manufacturing an article, and a detection method.

2. Description of the Related Art

An imprint technique has received a lot of attention as one of mass-production lithography techniques for magnetic storage media, semiconductor devices, and the like. The imprint technique transfers a pattern onto a substrate such as a silicon wafer or glass plate using a mold formed with a fine pattern as an original.

In an imprint apparatus using the imprint technique, a mold is pressed against a substrate via a resin supplied onto the substrate, and the resin is cured in this state. Then, the mold is peeled from the cured resin, thereby transferring a pattern of the mold onto the substrate. As a resin curing method, a light curing technique and thermal curing technique are available. Since the light curing technique can suppress an increase in pattern transfer time caused by temperature control and a decrease in dimensional precision of a pattern caused by a temperature change, it is suitable for the manufacture of semiconductor devices and magnetic storage media.

In a lithography apparatus represented by an imprint apparatus, a measure against foreign particles on a substrate or the like is important for enhancing the throughput. Especially in the imprint apparatus, since the mold and (a resin on the) substrate are brought into direct contact with each other unlike other lithography apparatuses, if a large foreign particle is present on the substrate, it is tucked down between the mold and substrate, thus damaging (the pattern of) the mold. Even a foreign particle as small as a pattern size is tucked down in the pattern of the mold, thus causing a defect in the pattern to be transferred to each shot region on the substrate.

As a detection apparatus (foreign particle inspection apparatus) for detecting a foreign particle on a substrate, for example, a scanning electron microscope (SEM), atomic force microscope (AFM), scanning tunneling microscope (STM), and the like are available. These detection apparatuses can detect a foreign particle on several-nm level, but a time required for detection of a foreign particle (detection time) is long. Hence, these detection apparatuses are not suited to scan the entire surface of a substrate.

As a detection apparatus which optically detects a foreign particle (by, for example, a dark field method), Surfscan SP2 (KLA-Tencor), LS6800 (Hitachi High-Technologies), WM-6000 (TOPCON), and the like are commercially available (see Japanese Patent Nos. 4183492 and 4316853). These detection apparatuses have a detection precision of about 30 nm, and do not require a long detection time, but they can cope with (be applied to) only a substrate having no base pattern such as a device pattern. Hence, these detection apparatuses cannot be used in actual processes.

As a detection apparatus which copes with a substrate having a base pattern, PUMA9500 (KLA-Tencor), IS3200 (Hitachi High-Technologies), ComPlus 4T (Applied Materials), and the like are available (see U.S. Pat. Nos. 7,410,737 and 6,862,491). These detection apparatuses detect a foreign particle while removing scattering light from a base pattern, but their detection precision largely depends on the base pattern using a Fourier filter, and their detection time does not sufficiently satisfy requirements.

Furthermore, 2830 (KLA-Tencor) commercially available as a defect inspection apparatus can detect a foreign particle of about 50 nm even for a substrate having a base pattern, but it requires a long detection time and is not suited to inspect the entire surface of the substrate. (see U.S. Pat. No. 6,313,467).

In consideration of application of the conventional detection apparatus or defect inspection apparatus to a lithography apparatus, conditions required for detection of a foreign particle present on a substrate having a base pattern, more specifically, the detection precision of about several ten nm and the detection time of about 50 substrates/hour cannot be satisfied. Also, in the imprint apparatus, since a technique for detecting a foreign particle on a substrate inside the imprint apparatus is required before an imprint process, a footprint reduction is also demanded.

### SUMMARY OF THE INVENTION

The present invention provides a technique advantageous to detect a foreign particle on a substrate with high precision and within a short period of time.

According to one aspect of the present invention, there is provided a detection apparatus for detecting a foreign particle on a substrate, including a plate having a first pattern on a first face, a second pattern laid out on a second face different from the first face, a driving mechanism configured to bring the substrate and the plate into contact with each other, a measurement unit configured to measure a relative position deviation between the first pattern and the second pattern in a state in which the substrate and the plate are in contact with each other, and a processing unit configured to execute processing for detecting a foreign particle on the substrate based on the position deviation measured by the measurement unit.

Further aspects of the present invention will become apparent from the following description of exemplary embodiments with reference to the attached drawings.

### BRIEF DESCRIPTION OF THE DRAWINGS

FIGS. 1A and 1B are views for explaining an overview of the present invention.

FIG. 2 is a view for explaining a position deviation of patterns laid out on a flat plate shown in FIG. 1B.

FIG. 3 is a view illustrating a warp of the flat plate caused by a foreign particle on a substrate.

FIG. 4 is a view showing an ideal model upon calculation of a relative position deviation of the pattern on the flat plate.

FIG. 5 is a graph showing the relationship among a pressure applied to the flat plate, the thickness of the flat plate and a radius of the warp of the flat plate, and a size of a foreign particle on the substrate.

FIG. 6 is a graph showing the relationship between a size of a foreign particle on the substrate and a relative position deviation amount of the patterns on the flat plate.

FIG. 7 is a schematic view showing an example of the practical arrangement of a flat plate used in a detection apparatus according to one aspect of the present invention.

FIG. 8 is a view for explaining an example of a measurement unit used to measure a relative position deviation of the patterns on the flat plate.

FIG. 9 is a view for explaining how to calculate a position of a foreign particle on the substrate.

FIG. 10 is a schematic view showing the arrangement of a detection apparatus according to one aspect of the present invention.

FIG. 11 is a schematic view showing the arrangement of a detection apparatus according to one aspect of the present invention.

FIG. 12 is a schematic view showing a layout of the patterns on the flat plate and the measurement unit of the detection apparatus shown in FIG. 11.

FIG. 13 is a schematic view showing the arrangement of a lithography apparatus according to one aspect of the present invention.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

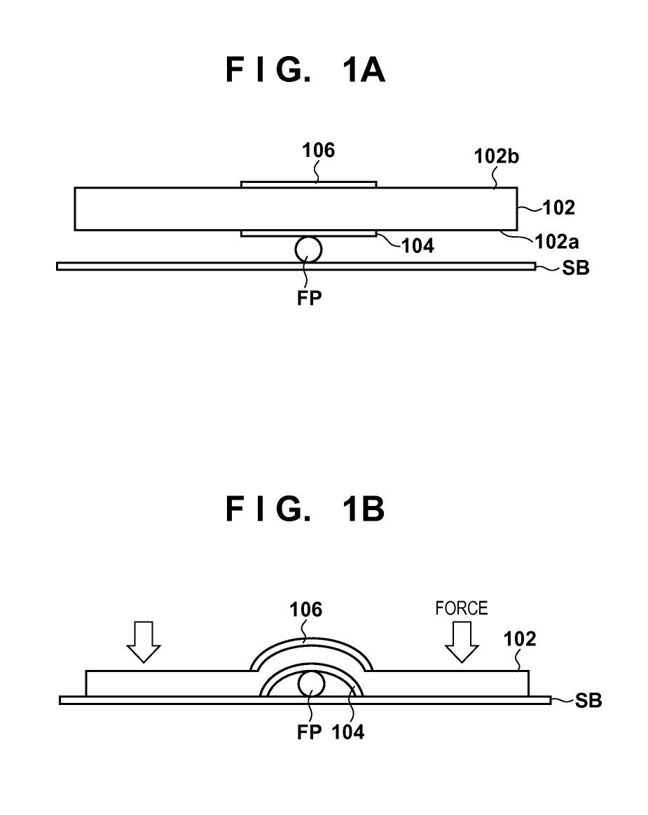

An overview of the present invention will be described below with reference to FIGS. 1A and 1B. FIG. 1A shows a state in which a flat plate 102 included in a detection apparatus according to one aspect of the present invention contacts a foreign particle FP (foreign substance) on a substrate SB. From the state shown in FIG. 1A, when the substrate SB and flat plate 102 are relatively moved, and when the substrate SB and flat plate 102 are brought into contact with each other by, for example, applying a force to the flat plate 102, a portion around the foreign particle FP of the flat plate 102 is deformed (bulged), as shown in FIG. 1B. Therefore, relative positions of a pattern (first pattern) 104 laid out on a face (first face) 102a on the substrate side of the flat plate 102 and a pattern (second pattern) 106 laid out on a face (second face) 102b on the side opposite to the face on the substrate side of the flat plate 102 are deviated.

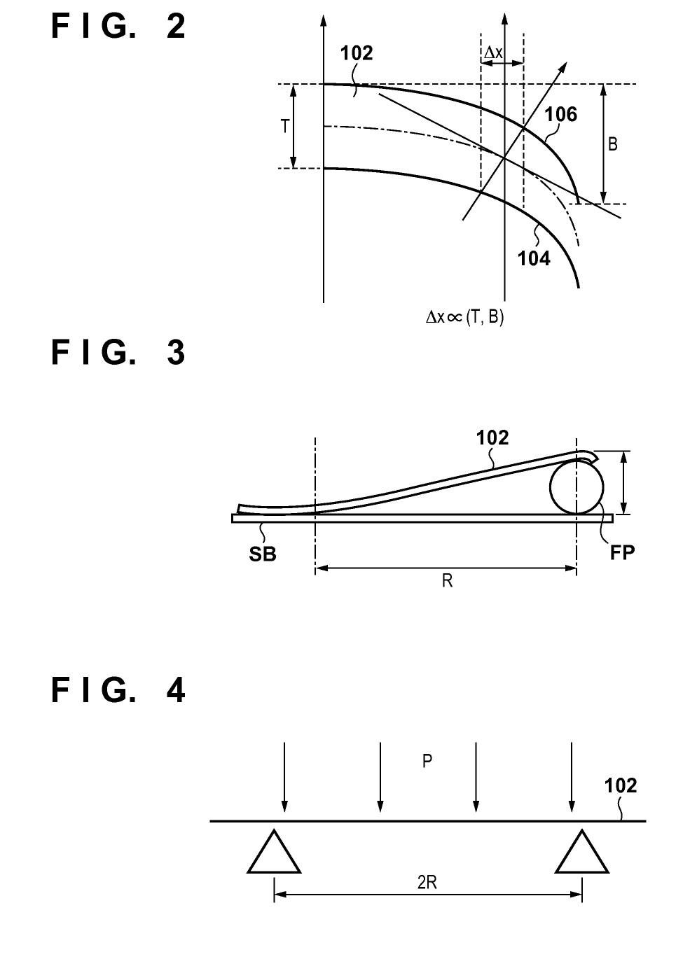

A relative position deviation between the patterns 104 and 106 shown in FIG. 1A will be described in detail below with reference to FIG. 2. Let T be a thickness of the flat plate 102, and B be a warp amount (curvature) of the portion around the foreign particle FP of the flat plate 102. In this case, the patterns 104 and 106 are deviated in opposite directions with respect to a reference line at the central position of the flat plate 102, and a relative position deviation Δx between the patterns 104 and 106 increases in proportion to the thickness T and the warp amount B of the flat plate 102.

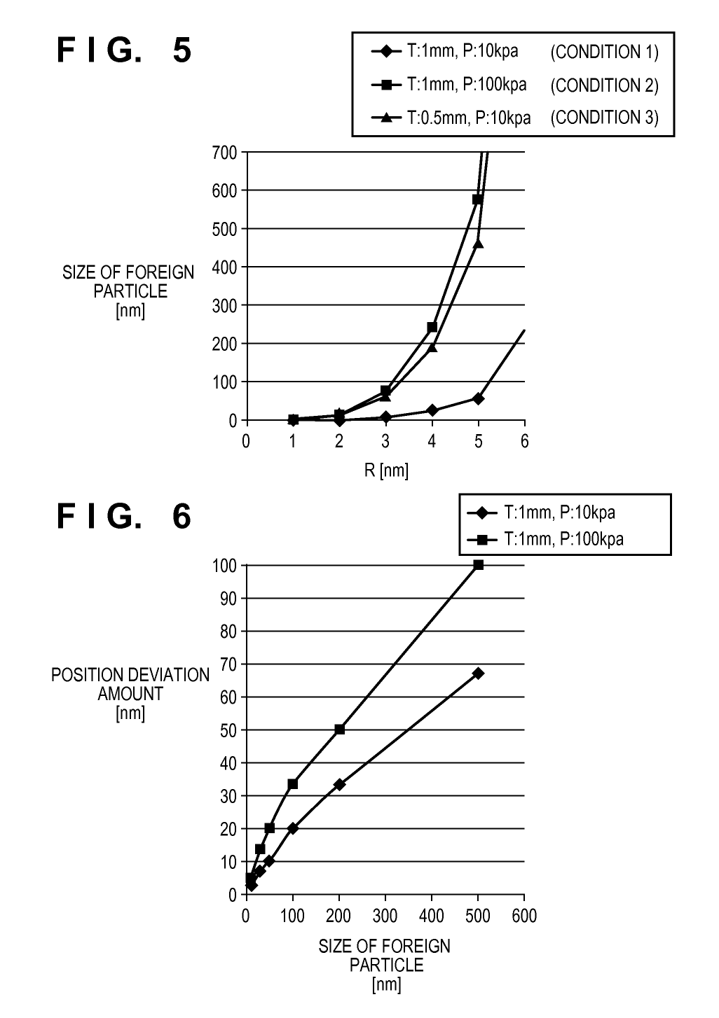

Thus, as shown in FIG. 3, a relationship between a size of the foreign particle FP and a relative position deviation (position deviation amount) between the patterns 104 and 106 is calculated by simulation based on the warp amount of the flat plate 102 caused by the foreign particle FP on the substrate SB. Such simulation is made using an ideal model shown in FIG. 4, more specifically, an ideal model which applies a uniform pressure (weight) P onto the entire surface of the flat plate 102 while two points of edge portions of the flat plate 102 are constrained. The flat plate 102 is made up of quartz as a material, and has a longitudinal elastic modulus E=71500 [N/mm²] and a Poisson ratio v=0.335. FIG. 5 shows a calculation result of a warp amount W of the flat plate 102 as a size of the foreign particle FP using the pressure P [kPa], the thickness T [mm] of the flat plate 102, and a radius R [mm] of a warp of the flat plate 102 as variables. In FIG. 5, the ordinate plots a size [nm] of the foreign particle, and the abscissa plots the radius R [mm] of the flat plate 102.

Referring to FIG. 5, under a condition (condition 1) including the thickness T=1 [mm] of the flat plate 102 and the pressure P=10 [kPa], the radius R of the warp of the flat plate 102 with respect to the foreign particle FP having a size of about 100 nm (small size) is about 5 mm. Under a condition (condition 2) including the thickness T=1 [mm] of the flat plate 102 and the pressure P=100 [kPa] and a condition (condition 3) including the thickness T=0.5 [mm] of the flat plate 102 and the pressure P=10 [kPa], the radius R of the warp of the flat plate 102 with respect to the foreign particle FP having a size of about 100 nm is about 3 mm.

In this case, since a larger radius R of the warp of the flat plate 102 with respect to the foreign particle FP of the same size means a smaller curvature of the flat plate 102, a relative position deviation amount between the patterns 104 and 106 is smaller. Therefore, a sensitivity to the relative position deviation between the patterns 104 and 106 is low (insusceptible). For example, the conditions 2 and 3 can detect the foreign particle FP of the same size more sensitively than the condition 1.

As described above, since the warp of the flat plate 102 is generated on the mm order with respect to the foreign particle FP of about several ten nm, even when a size of an object to be detected is on the mm order, it can be detected as the relative position deviation between the patterns 104 and 106. However, these conditions largely depend on the physical properties of a material of the flat plate 102. Therefore, the condition can be optimized according to the physical properties of a material used as the flat plate 102.

A detection limit size of the foreign particle FP on the substrate SB will be described below with reference to FIG. 6. FIG. 6 shows the relationship between the size of the foreign particle FP on the substrate SB and the relative position deviation amount between the patterns 104 and 106 on the flat plate 102. In FIG. 6, the ordinate plots the relative position deviation amount [nm] between the patterns 104 and 106, and the abscissa plots the size [nm] of the foreign particle FP. Also, in FIG. 6, the relative position deviation amount Δx=(the size of the foreign particle FP/R) between the patterns 104 and 106 for the sake of simplicity.

As can be seen from FIG. 6, when a measurement unit which can measure the relative position deviation between the patterns 104 and 106 at a measurement precision (resolution) of about several nm, the foreign particle FP of about 10 nm can be detected. However, only the resolution of the measurement unit cannot determine the detection precision of the foreign particle FP. To determine the detection precision of the foreign particle FP, a flatness of a substrate (wafer or glass plate) used in the manufacture of a semiconductor device and noise caused by scattering light from a base pattern included in a measurement signal have to be taken into consideration.

In the present invention, since the patterns 104 and 106 on the flat plate 102 are detected, and the foreign particle FP on the substrate SB is detected based on a change in relative position deviation between the patterns 104 and 106, a local change in flatness (roughness) of the substrate SB and high-frequency components become noise. Therefore, noise has to be predicted from a flatness process performance such as CMP (Chemical Mechanical Polishing). In general, in physical polishing by CMP, a flatness of a substrate is locally changed depending on the line width and pattern density of a base pattern. Also, as is known, a global flatness is generated on the entire substrate.

In such case, as for the local flatness of the substrate, flatness components in shot regions having an identical base pattern are extracted in advance, and are subtracted from a measurement result, thus reducing noise. On the other hand, as for the global flatness of the substrate, for example, curvature components of lower orders are filtered using statistical processing or the like to reduce noise, thus suppressing deterioration of the detection precision of a foreign particle.

Also, since processing required to detect a foreign particle on a substrate can simultaneously calculate the flatness of the substrate, it can also be used in measurement of the flatness of the substrate.

Furthermore, as for the influences of scattering light from the base pattern, noise can be greatly reduced by devising the arrangement of the flat plate 102 or using an oblique incidence optical system as a measurement unit required to measure the relative position deviation between the patterns 104 and 106.

As described above, the present invention allows foreign particle detection at a resolution as very high as about several ten nm and insusceptible to the influence from a base pattern. In other words, the present invention can satisfy a condition required for detection of a foreign particle on a substrate having a base pattern, more specifically, the detection precision of about several ten nm and a detection time of about 50 substrates/hour.

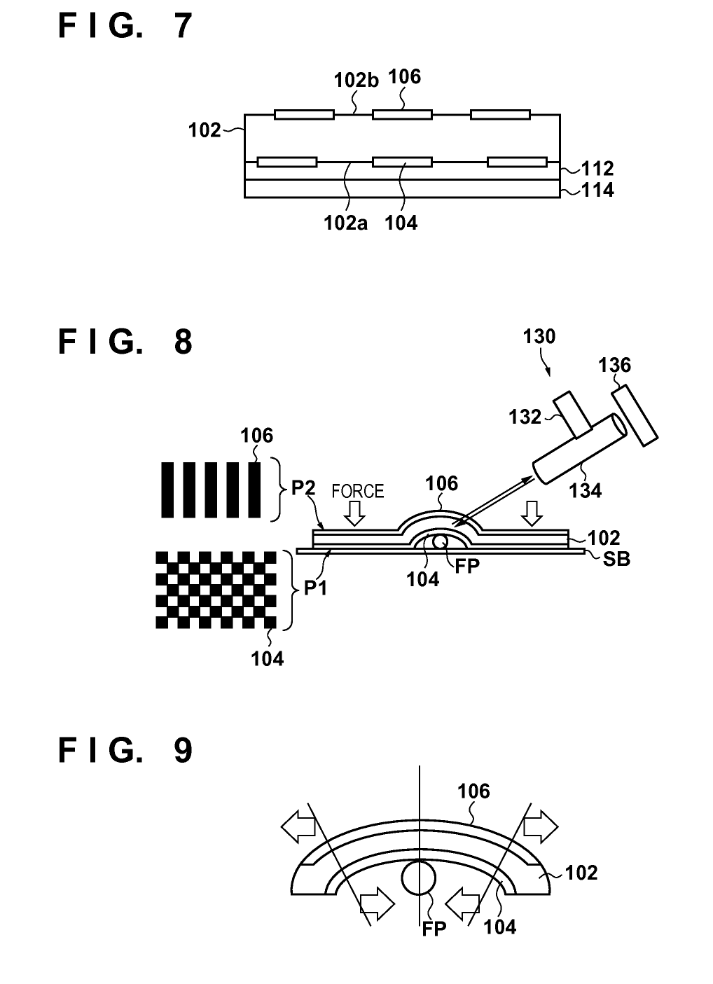

An example of the practical arrangement of the flat plate 102 used in a detection apparatus according to one aspect of the present invention will be described below with reference to FIG. 7. The flat plate 102 is made up of a material having transparency with respect to light required to observe the patterns 104 and 106. For example, when light required to observe the patterns 104 and 106 is visible light, the flat plate 102 is preferably made up of glass or quartz as a material.

The patterns 104 and 106 are respectively formed on the faces 102a and 102b of the flat plate 102, and a relative position deviation between the patterns 104 and 106 can be measured by simultaneously observing the patterns 104 and 106.

As the patterns 104 and 106, a line-and-space repetition pattern, crisscrossed grating pattern, checkered grating pattern, and the like are typically used, but the present invention is not limited to such specific patterns. The patterns 104 and 106 may be formed as, for example, steps by etching (the faces 102a and 102b of) the flat plate 102. In order to enhance the contrast of a measurement signal, a light-shielding member such as a metal film may be formed on the flat plate 102, and may be etched to form each of the patterns 104 and 106. Furthermore, the patterns 104 and 106 may be formed by doping substances (ions) into (the faces 102a and 102b of) the flat plate 102 by ion implantation.

On the face 102a on the substrate side of the flat plate 102, that is, on the lower surface of the pattern 104, a light-shielding film 112 which shields light reflected by the substrate SB is preferably formed. Thus, upon observation of the patterns 104 and 106, noise light from a base pattern of the substrate SB can be suppressed. Therefore, a decrease in measurement precision upon measuring the relative position deviation between the patterns 104 and 106 can be suppressed, thereby improving the resolution of foreign particle detection.

When the pattern 104 is formed as steps, a foreign particle FP on the substrate SB is tucked down into the step, and disturbs deformation of the flat plate 102, resulting in a decrease in foreign particle detection precision or a foreign particle detection failure. Thus, the light-shielding film 112 may function as a member which fills the steps that form the pattern 104 to make a contact face with the substrate SB be flat as shown in FIG. 7. In addition to the light-shielding film 112, a member which fills the steps that form the pattern 104 to make a contact face with the substrate SB be flat may be arranged. In this case, this member has a refractive index different from that of the flat plate 102.

The light-shielding film 112 has to be made up of a material which does not transmit light required to observe the patterns 104 and 106. However, when the light-shielding film 112 does not have a large refractive index difference from the pattern 104, since the contrast of a measurement signal cannot be obtained, the material of the light-shielding film 112 has to be appropriately selected. In this embodiment, the flat plate 102 is configured by forming the pattern 106 of a metal film, the pattern 104 of steps, and the light-shielding film 112 of a metal film.

On a face, which contacts the substrate SB, of the flat plate 102, a water-repellant film 114 is preferably formed in consideration of a contact between the substrate SB and flat plate 102. In this embodiment, the substrate SB and flat plate 102 are brought into contact with each other while an adherence layer (adherence agent) is coated (supplied) on the substrate SB. Therefore, when the adherence layer coated on the substrate SB and the flat plate 102 are brought into contact with each other, if their adhesion strength is high or a contact area between the substrate SB (adherence layer) and flat plate 102 is large, the substrate SB and flat plate 102 may not be separated from each other. Thus, the water-repellant film 114 having water repellency with respect to the adherence layer is formed (coated) in advance on the face, which contacts the substrate SB, of the flat plate 102, the substrate SB and flat plate 102 can be easily separated from each other. In this embodiment, the water-repellent film 114 is formed on the face on the substrate side of the light-shielding film 112. However, when the light-shielding film 112 is not formed on the flat plate 102, the water-repellent film 114 may be formed on the face 102a on the substrate side of the flat plate 102. Alternatively, the water-repellent film 114 may function as a member which fills steps that form the pattern 104 to make a contact face with the substrate SB be flat. Note that the adherence layer is coated on the substrate SB before the substrate SB is brought in the lithography apparatus so as to make the substrate and resist (photosensitive agent) or resin be solidly in tight contact with each other. Especially, in the imprint apparatus, since a mold is peeled (released) from a resin (cured resin) on a substrate, the adherence layer which can prevent the cured resin corresponding to a resist pattern from being peeled from the substrate is required.

An example of a measurement unit 130 required to measure a relative position deviation between the patterns 104 and 106 on the flat plate 102 will be described below with reference to FIG. 8. In this embodiment, a case will be exemplified wherein the patterns 104 and 106 are grating patterns having different grating pitches, and a moiré image (moire fringes) is formed by the relative relationship between the patterns 104 and 106. However, the patterns 104 and 106 may be line-and-space patterns as long as they can form a moiré image.

Letting P1 be a grating pitch of the pattern 104 formed on the face 102a of the flat plate 102 and P2 (P1<P2) be a grating pitch of the pattern 106 formed on the face 102b of the flat plate 102, a pitch P3 of the moiré image is expressed by:

1/P3=(1/P1)−(1/P2) (1)

In this case, letting Δx be a relative position deviation amount between the patterns 104 and 106 on the flat plate 102, a shift amount of the pitch P3 of the moiré image is proportional to a phase difference of a period Pa (=(P1+P2)/2). Therefore, a relative shift amount S of the moiré image is expressed by:

S=(Δx/Pa)·P3 (2)

Referring to equations (1) and (2), by appropriately selecting (setting) the grating pitches P1 and P2, an actual position deviation amount Δx can be measured in an enlarged scale (that is, at higher precision). This means that a numerical aperture (NA) can be practically reduced by increasing the pitch P3 of the moiré image without increasing an optical magnification of an optical system included in the measurement unit 130. In other words, a moiré measurement method is advantageous since it can improve the measurement precision of the relative position deviation between the patterns 104 and 106 even when the measurement unit 130 is configured by a simple optical system.

FIG. 9 shows, as the measurement unit 130, an oblique incidence optical system in which an optical path of light with which the patterns 104 and 106 are irradiated, and that of light from the patterns 104 and 106 are matched. In this case, since the patterns 104 and 106 have to generate diffracted light also in a direction perpendicular to a detection direction, at least one of the patterns 104 and 106 is required to be a crisscrossed grating pattern or checkered grating pattern. In this embodiment, a checkered grating pattern is laid out on the face 102a on the substrate side of the flat plate 102 as the pattern 104, and a line-and-space pattern is laid out on the face 102b on the side opposite to the face on the substrate side of the flat plate 102 as the pattern 106.

The reason why an oblique-incidence illumination system on the patterns 104 and 106 is adopted is not to detect 0th-order light from the faces 102a and 102b of the flat plate 102 and the surface (face on the flat surface side) of the substrate SB. Since the moiré measurement method measures a position deviation from imaged light rays of a predetermined order, 0th-order light becomes noise.

In this embodiment, the measurement unit 130 includes an illumination system 132, scope 134, and sensor 136 which detects a moiré image formed by light which has passed through the patterns 104 and 106. Light coming from the illumination system 132 illuminates the entire pattern 106 on the flat plate 102. Attention is focused on 0th-order light of light which has passed through the pattern 106. This 0th-order light passes through the pattern 106 and is diffracted (reflected) by the pattern 104. Although 1st-order light rays diffracted by the pattern 104 travel in four different directions, a grating pitch perpendicular to an illumination direction of the pattern 104 (in a direction parallel to the plane of the drawing) is designed so that two out of the four 1st-order light rays return in the incidence direction.

Furthermore, the two 1st-order light rays are diffracted by the pattern 106 again, and at least two or more diffracted light rays pass through the scope 134. In this case, 0th-order light reflected by the pattern 104 and the remaining two 1st-order light rays do not enter the scope 134. However, in order to obtain a pitch (P3) of a moiré image formed by pure 1st-order light of the at least two or more diffracted light rays which enter the scope 134, a numerical aperture (NA) of a pupil plane of the scope 134 has to be sufficiently small. Finally, the at least two or more diffracted light rays pass through the scope 134, and form a moiré image on the sensor 136.

Likewise, as for ±1st-order diffracted light rays which are emitted from the illumination system 132 and pass through the pattern 106, at least two or more diffracted light rays diffracted by the pattern 104 pass through the scope 134 and form a moiré image. In this case, the pattern 106 laid out on the face 102b of the flat plate 102 may be laid out on a plane optically conjugate with the face 102a of the flat plate 102 in place of the flat plate 102. For example, a reference plate formed with the pattern 106 may be laid out in the vicinity of a portion above the flat plate 102 or may be arranged inside the scope 134 or on an imaging surface of the sensor 136. However, in such case, it should be noted that a sensitivity to the relative position deviation between the patterns 104 and 106 is halved compared to the case in which the patterns 104 and 106 are laid out on the flat plate 102.

In this embodiment, the central wavelength of light from the illumination system 132 is 500 nm, an incidence angle of light which illuminates the patterns 104 and 106 is 0.1 (NA), the NA of light which illuminates the patterns 104 and 106 is 0.025, and that at the pupil plane of the scope 134 is 0.03. Also, the grating pitch of the pattern 106 is 9.03 μm, that of the pattern 104 in a direction perpendicular to the pattern 106 is 2.5 μm, and that of the pattern 104 in a direction parallel to the pattern 106 is 9 μm. Therefore, a magnification of a moiré image is ×300 from equations (1) and (2), and a pitch of the moiré image is 1355 μm.

The sensor 136 includes a CCD sensor or CMOS sensor, and has a field angle of Φ30 mm and a resolution of 10 μm/pixel. Therefore, by setting an optical magnification of the scope 134 to be 0.1, a range of Φ300 mm can be observed. Also, with respect to the pitch (1355 μm) of the moiré image, position measurement is executed using about 14 pixels. Furthermore, a sensitivity to a position deviation is 333 nm/pixel from a pixel/the magnification of the moiré image=100 nm/300. Therefore, since a position deviation of about several ten nm can be detected from sine wave analysis, inspection of a foreign particle of a size of about 100 nm can be coped with. When the detection precision of a foreign particle is required to be further improved, an observation region may be narrowed down or the magnification of the moiré image or the resolution of the sensor 136 may be improved to meet such requirement. However, as described above, the relationship between the pitch of the moiré image and the measurement precision of the position deviation is important, and the pitch of the moiré image is preferably about 1 mm.

Information of the moiré image detected by the sensor 136 includes that related to a relative position deviation between the patterns 104 and 106 on the flat plate 102 and that related to the flatness of the substrate SB in a state in which there is no foreign particle FP on the substrate SB. Therefore, (an image of) a reference moiré image or a relative reference position deviation between the patterns 104 and 106 in the state in which there is no foreign particle FP on the substrate SB is acquired in advance using, for example, a bare substrate, the flatness of which is guaranteed. Then, by comparing the reference moiré image (or reference position deviation) with a moiré pattern (a relative position deviation between the patterns 104 and 106) acquired in a state in which a foreign particle FP is present on the substrate SB, that is, at a foreign particle detection timing, a size and position of the foreign particle FP are calculated.

Upon calculating a size of the foreign particle FP, position measurement of the moiré image detected by the sensor 136 is executed for respective pitches on the entire measurement region. Likewise, position measurement of the reference moiré image is executed in advance for respective pitches, and position deviation amounts for respective pitch coordinates of the two images are calculated to acquire a position deviation map. Then, from this position deviation map, a size of the foreign particle FP is calculated for respective pitch coordinates using the relationship between the size of the foreign particle FP on the substrate SB and the relative position deviation amount between the patterns 104 and 106 on the flat plate 102, as shown in FIG. 6. Also, by specifying a deflection point at which the sign of a change in relative position deviation between the patterns 104 and 106 is reversed from the position deviation map, as shown in FIG. 9, a position of the foreign particle FP can be calculated.

This embodiment has explained the case in which the foreign particle FP is detected from the position deviation map in one direction. Also, position deviation maps in two directions, that is, X and Y directions, can be acquired. In this case, the pattern 106 may be changed from the line-and-space pattern to a crisscrossed grating pattern, or line-and-space patterns in the X and Y directions may be laid out in a checkered pattern at respective pitches of the moiré image.

Also, low-order components are extracted from the position deviation maps in the two directions as a global flatness of the substrate SB by frequency analysis to average position deviation maps for each shot region, thereby extracting them as flatness components in that shot region. The foreign particles can also be checked by eliminating these position deviation components. Therefore, by converting such position deviation components into a flatness, the flatness of the substrate SB can also be measured. Alternatively, after the position deviation maps in the two directions are converted into flatness maps, the flatness of the substrate SB may be calculated.

The position deviation measurement of the moiré image using two different pitches has been described so far. Also, a foreign particle can be measured from light intensities of the moiré image. In this case, overlapping patterns may have an equal pitch. By detecting light intensities from two patterns, a foreign particle on the substrate can be detected. Also, a foreign particle can be detected from a difference between moiré light intensities which are detected by the sensor and a reference moiré light intensity map.

A detection apparatus 1 according to one aspect of the present invention will be described below with reference to FIG. 10. The detection apparatus 1 is an apparatus (foreign particle inspection apparatus) which detects a foreign particle on the substrate SB. The detection apparatus 1 includes the flat plate 102 on which the patterns 104 and 106 are formed, a substrate holding unit 142 which holds the substrate SB, and a substrate driving unit 144 which drives the substrate holding unit 142 (by, for example, six-axis driving). Also, the detection apparatus 1 includes a flat plate holding unit 146 which holds the flat plate 102, and a flat plate driving unit 148 which drives the flat plate holding unit 146 (by, for example, six-axis driving). Furthermore, the detection apparatus 1 includes the measurement unit 130, a processing unit 150, and a storage unit 152.

In this embodiment, the flat plate holding unit 146 is configured to apply, to the flat plate 102, a pressure from the face 102b on the side opposite to the face 102a on the substrate side of the flat plate 102. In other words, the flat plate holding unit 146 also functions as a deforming unit which deforms the flat plate 102. The substrate driving unit 144 and flat plate driving unit 148 function as a moving mechanism (driving mechanism) which relatively move the substrate SB and flat plate 102 to be brought into contact with each other.

The flat plate 102 has the aforementioned arrangement and functions. In this embodiment, assume that the size of the flat plate 102 is larger than that of the substrate SB. More specifically, the size of the flat plate 102 is Φ450 mm, and that of the substrate SB is Φ300 mm. This size is advantageous in term of the throughput since foreign particle detection can be simultaneously applied to the entire surface of the substrate SB. However, even when the size of the flat plate 102 is smaller than or equal to that of the substrate SB, foreign particle detection can be applied to the entire surface of the substrate SB by dividing foreign particle detection regions.

The measurement unit 130 has the aforementioned arrangement, and measures a relative position deviation between the patterns 104 and 106 on the flat plate 102 in a state in which the substrate SB and flat plate 102 are in contact with each other.

The processing unit 150 systematically controls the respective units of the detection apparatus 1. Also, in this embodiment, the processing unit 150 executes processing for detecting a foreign particle on the substrate SB based on a relative position deviation between the patterns 104 and 106, which is measured by the measurement unit 130 (foreign particle detection processing), that is, the aforementioned processing. The storage unit 152 stores information required for the foreign particle detection processing executed by the processing unit 150, for example, a reference moiré image, a relative reference position deviation between the patterns 104 and 106, and the like in a state of no foreign particle FP on the substrate SB.

The foreign particle detection processing by the detection apparatus 1 will be described below. The substrate driving unit 144 drives the substrate holding unit 142, which holds the substrate SB, in a Z-axis direction to bring the substrate SB and flat plate 102 (that held by the flat plate holding unit 146) into contact with each other. In this case, the substrate holding unit 142 applies a pressure to the face 102b of the flat plate 102 to convex the flat plate 102 to the substrate side, so that the flat plate 102 is brought into contact with the substrate SB from its central portion (convex portion). Then, when the central portion of the flat plate 102 is in contact with the substrate SB, the pressure applied to the face 102b of the flat plate 102 is gradually reduced to zero to bring the substrate SB and flat plate into (tight) contact with each other while a gas (air) between the substrate SB and flat plate 102 is removed toward the outer periphery. In other words, before the substrate SB and flat plate 102 are in contact with each other, the flat plate 102 is deformed, so that it has a convex surface toward the substrate SB. Then, when the substrate SB and flat plate 102 are brought into contact with each other, a deformation amount of the flat plate 102 is reduced so as to increase a contact area between the substrate SB and the convex surface of the flat plate 102 step by step. Thus, a gas pool can be suppressed from being generated between the substrate SB and flat plate 102, thus setting an ideal contact state. By reducing a gas pool between the substrate SB and flat plate 102, a foreign particle on the substrate SB can be precisely reflected to a deformation of the flat plate 102. Also, since the contact area between the substrate SB and (the convex surface of) the flat plate 102 is gradually increased, when a large foreign particle is tucked down between the substrate SB and flat plate 102, further contacting of the substrate SB and flat plate 102 (foreign particle detection processing) can be aborted. Therefore, damages of the substrate SB and flat plate 102 by a foreign particle on the substrate SB can be eliminated. Note that the adherence layer or resist is coated on the substrate SB to also eliminate damages caused by a direct contact of the substrate SB and flat plate 102.

After the substrate SB and flat plate 102 are in contact with each other, the measurement unit 130 detects a moiré image which represents a relative position deviation between the patterns 104 and 106 on the flat plate 102. Then, as described above, the reference moiré image stored in the storage unit 152 is compared with the detected moiré image, thus detecting a foreign particle on the substrate SB.

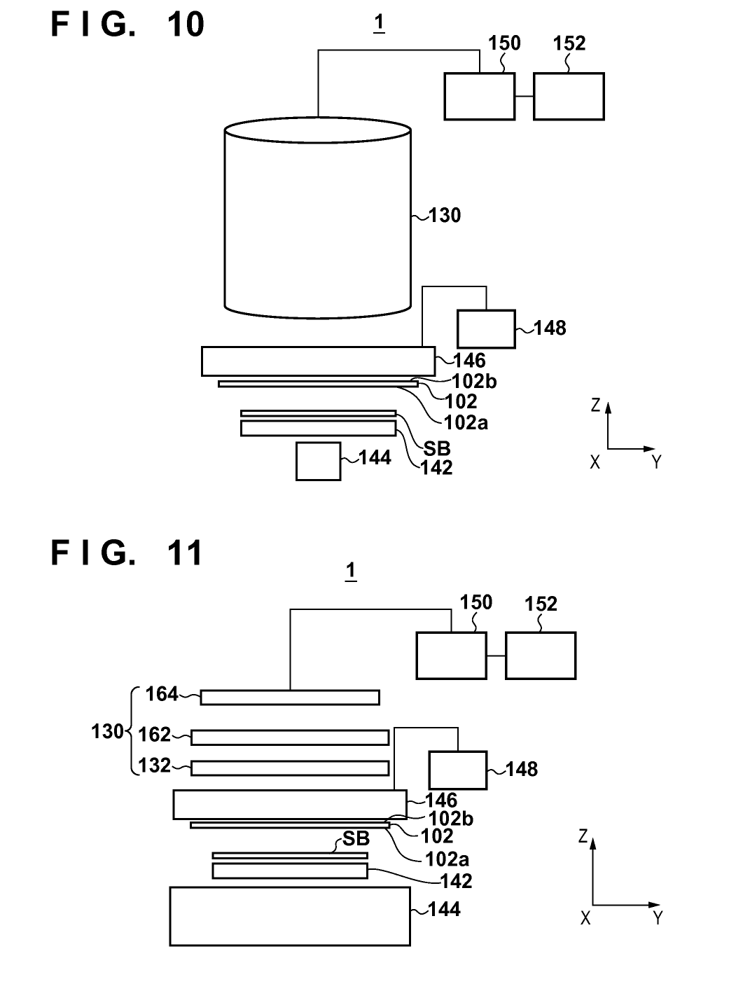

Another arrangement of the detection apparatus 1 according to one aspect of the present invention will be described below with reference to FIG. 11. The detection apparatus 1 shown in FIG. 11 includes the illumination system 132, an imaging system 162, and a line sensor 164 as the measurement unit 130. The imaging system 162 is, for example, an optical system which is configured by an SLA (SELFOC Lens Array) (Nippon Sheet Glass) in which a large number of refractive index distribution type lenses (SELFOC lenses) are arranged in an array, and forms one continuous image (moiré image) by the entire array. A moiré image detected by the line sensor 164 is stored in the storage unit 152.

The foreign particle detection processing by the detection apparatus 1 shown in FIG. 11 will be described below. The substrate driving unit 144 drives the substrate holding unit 142, which holds the substrate SB, in a Z-axis direction to bring the substrate SB and flat plate 102 (that held by the flat plate holding unit 146) into contact with each other. After the substrate SB and flat plate 102 are in contact with each other, the flat plate 102 is obliquely irradiated with linear light from the illumination system 132. Assume that the central wavelength of light from the illumination system 132 is 500 nm, an incidence angle of light which illuminates the patterns 104 and 106 is 0.2 (NA), and the NA of light which illuminates the patterns 104 and 106 is 0.025. Since the line length of light coming from the illumination system 132 is longer than 300 mm, the entire surface of the substrate SB can be measured by a single scan.

The substrate driving unit 144 drives (scans) the substrate holding unit 142 in a Y-axis direction, so that the entire surface of the substrate SB is scanned by the linear light from the illumination system 132. That is, the substrate holding unit 142 is controlled to function as a scanning mechanism which scans a moiré image with respect to the line sensor 164. In this embodiment, assume that the pattern 104 laid out on the face 102a on the substrate side of the flat plate 102 is a line-and-space pattern, and has a pitch of 9.03 μm. On the other hand, assume that the pattern 106 laid out on the face 102b on the side opposite to the face on the substrate side of the flat plate 102 is a checkered grating pattern. Also, assume that a grating pitch of the pattern 106 in a direction perpendicular to the pattern 104 is 5 μm, and that of the pattern 106 in a direction parallel to the pattern 104 is 9 μm. Furthermore, assume that the NA of a pupil plane of the imaging system 162 is 0.03.

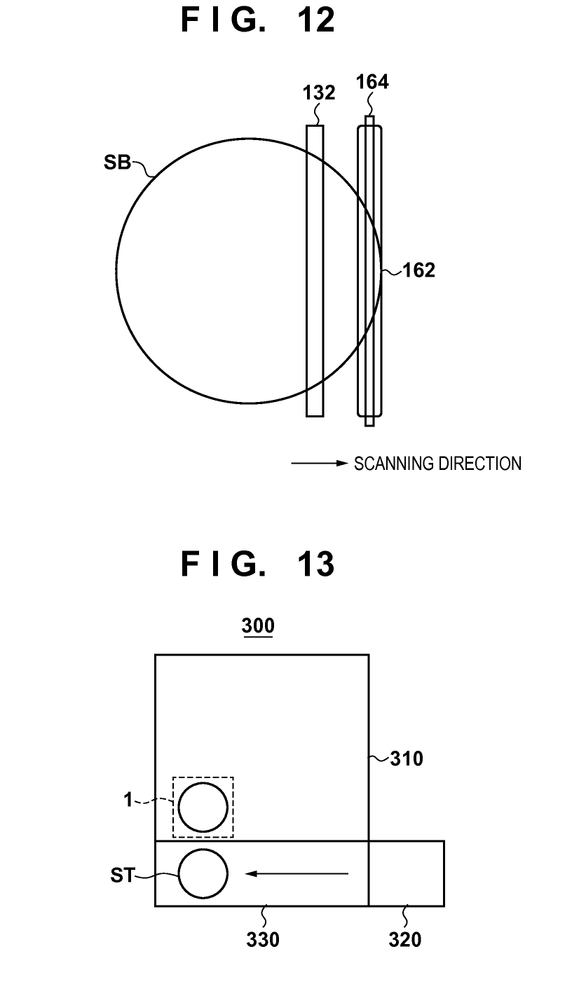

FIG. 12 shows a layout of the patterns 104 and 106 on the flat plate 102, and the measurement unit 130 (the illumination system 132, imaging system 162, and line sensor 164). Referring to FIG. 12, the illumination system 132, imaging system 162, and line sensor 164 are laid out in a direction perpendicular to the scanning direction, and the pattern 104 (line-and-space pattern) of the flat plate 102 is laid out in a direction parallel to the scanning direction.

In the detection apparatus 1 shown in FIG. 11, a moiré image is formed on the line sensor 164. Therefore, by storing a moiré image formed on the line sensor 164 in the storage unit 152 in synchronism with scanning by the substrate driving unit 144, a moiré image of the entire surface of the substrate SB can be obtained. When the imaging system 162 is an equal-magnification system, the line sensor 164 requires a line length of 300 nm or more. However, since a resolution can be about 0.1 mm, the line sensor 164 need only have 3000 pixels (300 mm/0.1 mm) or more. Then, a moiré image detected by the line sensor 164 is compared with the reference moiré image stored in the storage unit 152, thus detecting a foreign particle on the substrate SB.

As described above, according to the detection apparatus 1 of this embodiment, a foreign particle on the substrate SB can be detected at a detection precision of about several ten nm within a short period of time. Also, since the detection apparatus 1 has a simple arrangement, as described above, it can be easily built in a lithography apparatus or the like.

A lithography apparatus 300 according to one aspect of the present invention will be described below with reference to FIG. 13. The lithography apparatus 300 is an apparatus which transfers a pattern onto a substrate, and is embodied as an imprint apparatus in this embodiment. As shown in FIG. 13, the lithography apparatus 300 includes the detection apparatus 1, a transfer processing unit 310, a FOUP 320, and a substrate conveying unit 330. In this embodiment, the transfer processing unit 310 executes imprint processing for curing a resin while a mold is pressed against the resin supplied to a substrate, and peeling the mold from the cured resin. The FOUP 320 is a conveying container of a substrate, which is compliant with the SEMI (Semiconductor Equipment and Materials Institute) standard.

A substrate stored in the FOUP 320 is conveyed to the transfer processing unit 310 by the substrate conveying unit 330. The substrate conveying unit 330 also includes an alignment mechanism which aligns the substrate, and the like, and conveys the substrate while correcting a rotation and shift of the substrate. At a substrate entrance position of the transfer processing unit 310, the aforementioned detection apparatus 1 is arranged. Therefore, the substrate holding unit 142 and substrate driving unit 144 of the detection apparatus 1 can be substituted by a substrate stage and substrate chuck of the lithography apparatus 300. At this substrate entrance position, foreign particle inspection on the substrate is executed by the detection apparatus 1.

As described above, according to the lithography apparatus 300 of this embodiment, a foreign particle on a substrate can be detected immediately before transfer processing for transferring a pattern onto the substrate and inside the lithography apparatus 300. In other words, the lithography apparatus 300 can detect a foreign particle on a substrate, and can execute the transfer processing based on that detection result. Therefore, the lithography apparatus 300 can prevent damages of a mold, pattern transfer error, and the like caused a foreign particle, and can efficiently manufacture an article such as a semiconductor device. A method of manufacturing a device (semiconductor device, liquid crystal display element, or the like) as an article includes a step of transferring (forming) a pattern on a substrate (wafer, glass plate, film-shaped substrate, or the like using the lithography apparatus 300. This manufacturing step further includes a step of etching the substrate on which the pattern is transferred. Note that this manufacturing method includes another processing step of processing the substrate on which the pattern is transferred in place of an etching step when another article such as a pattern dot medium (recording medium) or optical element is to be manufactured.

The lithography apparatus 300 may also be used as a charged particle beam lithography apparatus, projection exposure apparatus, and the like in addition to the imprint apparatus. The charged particle beam lithography apparatus is a lithography apparatus, which transfers a pattern onto a substrate by drawing on a substrate using a charged particle beam. The projection exposure apparatus is a lithography apparatus, which transfers a pattern on a reticle onto a substrate by projecting the pattern on the reticle onto the substrate via a projection optical system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-237266 filed on Oct. 26, 2012, and No. 2013-197509, filed Sep. 24, 2013, which are hereby incorporated by reference herein in their entirety.

1. A detection apparatus for detecting a foreign particle on a substrate, comprising:
a plate having a first pattern on a first face;
a second pattern laid out on a second face different from the first face;
a driving mechanism configured to bring the substrate and the plate into contact with each other;
a measurement unit configured to measure a relative position deviation between the first pattern and the second pattern in a state in which the substrate and the plate are in contact with each other; and
a processing unit configured to execute processing for detecting a foreign particle on the substrate based on the position deviation measured by the measurement unit.

2. The apparatus according to claim 1, wherein the first face is a face on a substrate side of the plate, and
the second face is a face on a side opposite to the face on the substrate side of the plate.

3. The apparatus according to claim 1, wherein the second face is a face which is optically conjugate with the first face.

4. The apparatus according to claim 3, wherein the measurement unit includes a scope configured to optically detect the first pattern and the second pattern, and
the second face is a face inside the scope.

5. The apparatus according to claim 1, further comprising:
a deforming unit configured to deform the plate,
wherein the deforming unit deforms the plate to have a convex surface toward the substrate before the substrate and the plate are brought into contact with each other, and
the deforming unit reduces a deformation amount of the plate so as to increase a contact area between the substrate and the convex surface when the substrate and the plate are brought into contact with each other.

6. The apparatus according to claim 1, wherein the first pattern and the second pattern are grating patterns having different grating pitches, and
the measurement unit includes a sensor configured to detect a moiré image formed by light from the first pattern and the second pattern, and measures a relative position deviation between the first pattern and the second pattern based on the moiré image detected by the sensor.

7. The apparatus according to claim 6, wherein the sensor includes a line sensor, and
the apparatus further comprises a scanning mechanism configured to scan the moiré image on the line sensor.

8. The apparatus according to claim 2, wherein the first pattern and the second pattern are formed by a light-shielding member or a step.

9. The apparatus according to claim 2, wherein the first pattern is formed by a step,
the plate includes a member which fills the step to make a contact face with the substrate to be flat, and
the member has a refractive index different from a refractive index of the plate.

10. The apparatus according to claim 1, wherein the plate has a light-shielding film, which shields light reflected by the substrate, on the face on the substrate side.

11. The apparatus according to claim 1, wherein the plate has a water-repellent film, which has water repellency against an adherence material supplied to the substrate, on a contact face with the substrate.

12. A detection apparatus for detecting a foreign particle on a substrate, comprising:
a plate having a first pattern on a first face;
a second pattern laid out on a second face different from the first face;
a driving mechanism configured to bring the substrate and the plate into contact with each other;
a measurement unit configured to measure light intensities from the first pattern and the second pattern in a state in which the substrate and the plate are in contact with each other; and
a processing unit configured to execute processing for detecting a foreign particle on the substrate based on the light intensities measured by the measurement unit.

13. A lithography apparatus for transferring a pattern onto a substrate, comprising a detection apparatus for detecting a foreign particle on the substrate, said detection apparatus comprising:
a plate having a first pattern on a first face;
a second pattern laid out on a second face different from the first face;
a driving mechanism configured to bring the substrate and the plate into contact with each other;
a measurement unit configured to measure a relative position deviation between the first pattern and the second pattern in a state in which the substrate and the plate are in contact with each other; and
a processing unit configured to execute processing for detecting a foreign particle on the substrate based on the position deviation measured by the measurement unit.

14. The lithography apparatus according to claim 13, wherein the lithography apparatus transfers the pattern onto the substrate by curing a resin in a state in which the resin on the substrate and a mold are in contact with each other.

15. A method of manufacturing an article, the method comprising:
transferring a pattern on a substrate using a lithography apparatus; and
processing the substrate on which the pattern has been transferred,
wherein the lithography includes a detection apparatus for detecting a foreign particle on the substrate, and
wherein the detection apparatus includes:
a plate having a first pattern on a first face;
a second pattern laid out on a second face different from the first face;
a driving mechanism configured to bring the substrate and the plate into contact with each other;
a measurement unit configured to measure a relative position deviation between the first pattern and the second pattern in a state in which the substrate and the plate are in contact with each other; and
a processing unit configured to execute processing for detecting a foreign particle on the substrate based on the position deviation measured by the measurement unit.

16. A detection method for detecting a foreign particle on a substrate, the method comprising:
bringing the substrate and a plate having a first pattern on a first face into contact with each other;
measuring a relative position deviation between the first pattern and a second pattern laid out on a second face different from the first face in a state in which the substrate and the plate are in contact with each other; and
executing processing for detecting a foreign particle on the substrate based on the measured position deviation.

17. A detection method for detecting a foreign particle on a substrate, the method comprising:
bringing the substrate and a plate having a first pattern on a first face into contact with each other;
measuring light intensities from the first pattern and a second pattern laid out on a second face different from the first face in a state in which the substrate and the plate are in contact with each other; and
executing processing for detecting a foreign particle on the substrate based on the measured light intensities.
